(19) United States
(12) Patent Application Publication
(10) Pub. No.: US 2007/0268685 A1
(43) Pub. Date: Nov. 22, 2007

(54) Forklift activated mirror alert

(76) Inventors: David A. Fossier, Cincinnati, OH (US); William Chernick, Cincinnati, OH (US)

Correspondence Address: William M. Selenke, 5 Drummond St., Cincinnati, OH, 45218, US

(21) Appl. No.: 11/437,093

(22) Filed: May 19, 2006

(51) Int. Cl. F21V 33/00

(52) U.S. Cl. 362/135; 340/815.4; 359/601

(57) ABSTRACT

The invention is a warning or information system which has a flat curved mirror; flat mirror, half dome, full dome or any shape semi transparent mirror with a means to activate the warning or information mirror system,. The system has a signal transfer means, a warning or information light placed behind the mirror. Illumination from that warning or information light passes through the mirror to warn or provide information to the client. A detection means transfers information through a signal transfer means which activates the warning or information light behind the transparent mirror. A timing device deactivates said warning light after a preset time interval or the device is deactivated when the stimulus for the activation means exits the area. Optionally, an auditory alarm is activated by the signal transfer means to complement the visual display. The visual display may be a programmable scrolling message board with a message such as “Forklift Approaching.” A further option is that the system has a failsafe circuitry that will flash a green LED (or other type of visual display) to indicate that the Mirror Alert System is functioning.

### FIELD OF INVENTION

The invention is concerned with systems that warn workers, pedestrians, patrons, and forklift operators of danger. More specifically, the invention is concerned with curved mirrors which reflect panoramic views. In particular, the convex mirrors, half dome (180 degree) mirrors, and full dome (360 degree) mirrors of the present invention are coated with a semi transparent reflective material so that light sources, including light bulbs, light emitting diodes (LED's), when placed behind the mirror will flash a warning or message through the mirror.

### BACKGROUND OF INVENTION

The present invention addresses the need to warn workers in a crowded manufacturing and warehousing environment. The invention is concerned with convex, flat, flat curved, half dome, and full dome mirrors that provide information useful for those in the jumble of sensory stimuli that is in the modern indoor work environment of a manufacturing facility or warehouse. A secondary light through the mirror provides a unique visual stimulation to call attention to the workers and patrons in chaotic environments.

Another application of the present invention would be to use the backlit mirror as a POP (point of purchase) display. The display would have a customer's product logo (or other text or graphics) illuminated from inside the mirror when customers approach the product display. One application for this would be to place the mirror by the cooler in a carryout or other store. This display could have a beer or other beverage logo. The mirror would double as a security device for the store clerks to monitor the store. The POP mirror would be of any size or shape (i.e. convex, flat, half dome or full dome etc). A graphics transparency would be mounted behind the mirror and illuminated by a lightbox or another type of light source so the graphics appear only when activated. A motion sensor or timer would be used to activate the light source.

A more specialized environment useful for the present invention is that of a dimly lighted cocktail bar. The present invention could call attention to a specific product without jarring the patron attention.

The present invention, a mirror warning or information system, is useful in a modern factory or warehouse for commercial goods. Modern factories and warehouses of packaged products are almost inconceivable without forklift vehicles. Manufactured goods are placed on pallets, usually wood, which are commonly four feet by four feet. On this four by four pallet, the commodity goods are stacked (palletized) about four to six feet high. Often two such pallets are carried on the same forklift, sometimes side by side; in other instances one on top of the other. Since these pallets are in front of the forklift driver, the driver often cannot see and thus by OSHA standards he must drive backwards. The efficient running of a factory or warehouse is contingent upon goods being moved as quickly as possible. These fast moving forklifts are very heavy and pose a danger to anything or anyone getting in their path. For this reason, drivers have good reflexes and can maneuver a forklift at a relatively high rate of speed.

An ordinary visit to a factory or warehouse can be an enlightening and a frightening experience. Forklifts are moving at high speed and the drivers have to contend with limited vision in front of him as well as blind corners and intersections. A worker or visitor on foot should remain in safety areas and be alert to forklift traffic. In fact, a common feature of factories and warehouses are safety mirrors. The typical forklift has a forklift horn to warn workers of approaching forklift traffic. The present invention turns a passive mirror into an active alarm to warn pedestrians and other forklift operators of an approaching forklift. In mirror jargon, 1 inch equals 1 foot. For example, a typical commercial 26 inch convex mirror provides a 26 foot radius of safety. The present invention allows the same 26 inch convex mirror to be seen up to a distance of 100 feet.

These mirrors have one major disadvantage the distance at which they show objects is in direct proportion to the diameter of the mirror. By the time these mirrors clearly show a rapidly approaching forklift, that forklift may be quite close. The present invention is concerned with convex, flat, curved half dome and full dome mirrors that provide additional important information concerning the location of an approaching forklift. Specifically the present invention is concerned with receiving information from the moving forklift, processing the information and sending it to a light behind a semi transparent mirror. In the back of that mirror and shining through the reflective surface are various signals warning of the approach of the forklift. Most typically these warnings would flash Caution with an arrow pointing towards the approaching forklift. This signal would be activated such that the warning signs will remain in the mirror for the limited times that would be required for the forklift to move past the danger area. An optional auditory warning could be activated by the present invention. A timed shutoff of the warning signs is provided or they can be shutoff as the forklift exits the area.

The preferred embodiment of the present invention comprises a means of determining the direction of motion of the forklift when that forklift is in the danger area. The forklift is detected by a light beam that is reflected back from a special retroreflector on the forklift. As a forklift passes the primary sensor will detect the retroreflector then a secondary sensor will detect the forklift to determine the direction of travel. The warning system is only activated as the forklift traffic approaches the danger area and not when they exit the area. Microwaves or other sensing means may be used to detect the forklift and its direction of travel.

There is a large working technology and art of mirrors. Ordinarily, mirrors are silvered so thickly that little if any light can pass from the rear of the mirror through the mirror to the front. However, the present invention requires semi reflective mirroring. That is the reflective mirror surface placed on the mirror is at a coated depth wherein light can readily pass through it. Specifically the present invention comprises a light source behind this semi reflective mirror. This light source provides a signal, for example “Caution” and an arrow pointing in the direction of the oncoming potential danger. This light is activated by a warning means which detects the movement of the passing forklifts.

Within the scope of the present invention are convex mirrors, flat, flat curved, half dome and full dome mirrors.

### SUMMARY OF INVENTION

The invention is a warning or information system which has a flat curved mirror; flat mirror, half dome, full dome or any shape semi transparent mirror with a means to activate the warning or information mirror system. The system has a signal transfer means and a warning or information light placed behind the mirror. Illumination from that warning or information light passes through the mirror to warn or provide information. A detection means transfers information through a signal transfer means which activates the warning or information light behind the semi transparent mirror. A timing device deactivates said warning light after a preset time interval or the device is deactivated when the stimulus for the activation means exits the area. Optionally, an auditory alarm is activated by the signal transfer means to complement the visual display.

The signal transfer means is either wireless or with wires and may activate an auditory alarm. Optionally the warning light is a laser which will project an image (text or graphics) on the surface of the mirror which is visible only when activated. The image may be a light box with graphics overlay so a full color image will be visible behind the mirror when activated. Likewise, the image may be a programmable scrolling message board with a message such as “Forklift Approaching.” A further option is that the system has a failsafe circuitry that will flash a green LED (or other type of visual display) to indicate that the Mirror Alert System is functioning.

The present invention is useful to warn of forklift movements in a warehouse or as an advertising display unit.

### BRIEF DESCRIPTION OF THE FIGURES

FIG. 1 shows a schematic of the forklift activated curved warning mirror system.

FIG. 2 shows a schematic of the warning system in place.

FIG. 3 shows two views of an embodiment of Forklift Activated Mirror Alert.

FIG. 4 shows a series of light emitting diodes placed on PC boards in an arrangement that outlines the word Caution, as well as direction arrows □ and □.

FIG. 5 illustrates a closed upright commercial cooler for soft drinks.

FIG. 6 shows an outline of a bar establishment.

### DESCRIPTION OF THE FIGURES

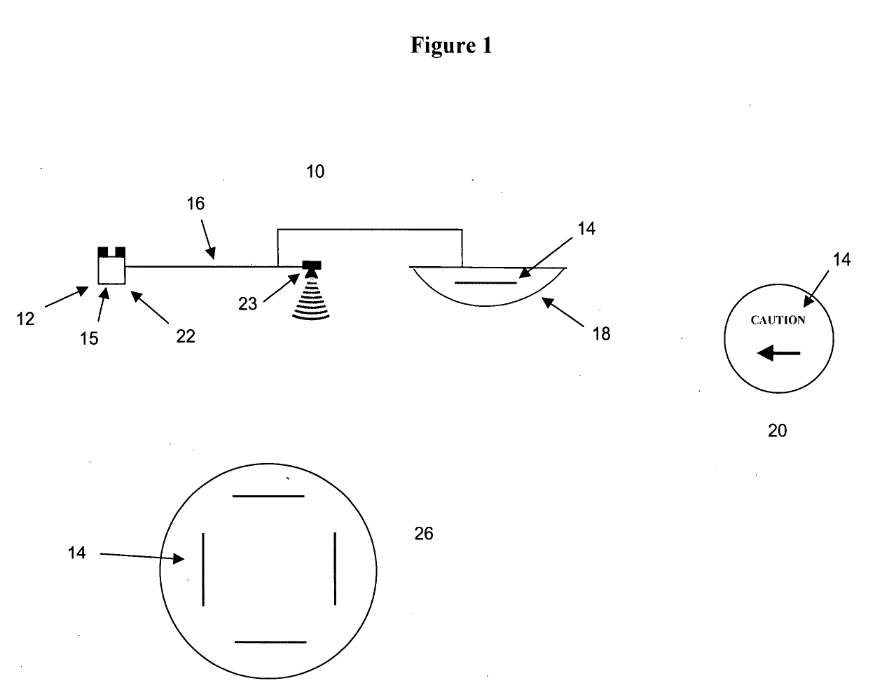

FIG. 1 shows a schematic of the forklift activated curved warning mirror system 10. The invention comprises a means 12 to detect the approaching forklift. This detection means 12 activates the warning light 14 through signal transfer means 16. Signal transfer means 16 can be either wireless or with wires. Information from warning light 14 passes through the mirror 18 to warn of the approaching vehicle. Front view 20 of mirror 18 shows that one version of mirror 18 is convex. An optional auditory alarm 23 activated by signal transfer means 16. Interrupter device 15 will provide a flashing warning light 14 and repeating short auditory alarm 23. Timing device 22 deactivates warning light 14 and alarm 23 after a preset time which indicates that the forklift has passed the danger zone. Front view 20 of convex mirror shows the warning light 14. A convex mirror is a common mirror of the preferred embodiment. However a flat, curved, half dome or full dome mirror as shown in 26 may be useful in certain situations. Warning light 14 placed behind curved mirror 18 may be a programmable scrolling message board so that a message, such as “Forklift Approaching” is visible when activated.

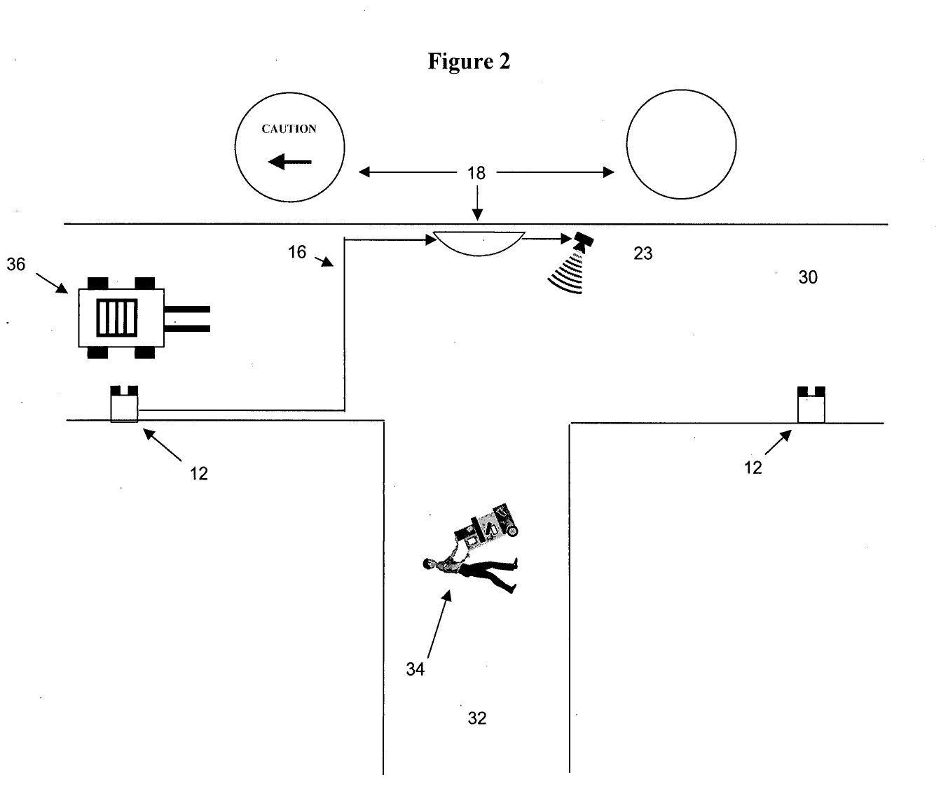

FIG. 2 shows a schematic of the warning system in place. In this instance there is a longer corridor 30. Connecting to larger corridor 30 is access corridor 32. A pedestrian 34 is shown walking across access corridor 32. Forklift 36 could prove a danger to pedestrian 34. Detection means 12 senses the presence of the forklift 36 moving toward the access corridor 32. The activated detection means 12 produces a signal, which is transferred via transfer means 16 to convex mirror 18 to warn of approaching vehicle 36. Optional auditory alarm 23 is activated by signal transfer and the lighted warning signal “Caution” with arrow pointing in the direction of the approaching forklift 36. The dome mirror alert can be constructed so that pedestrian and forklift operators are warned in cross aisles as they approach a 4-way intersection.

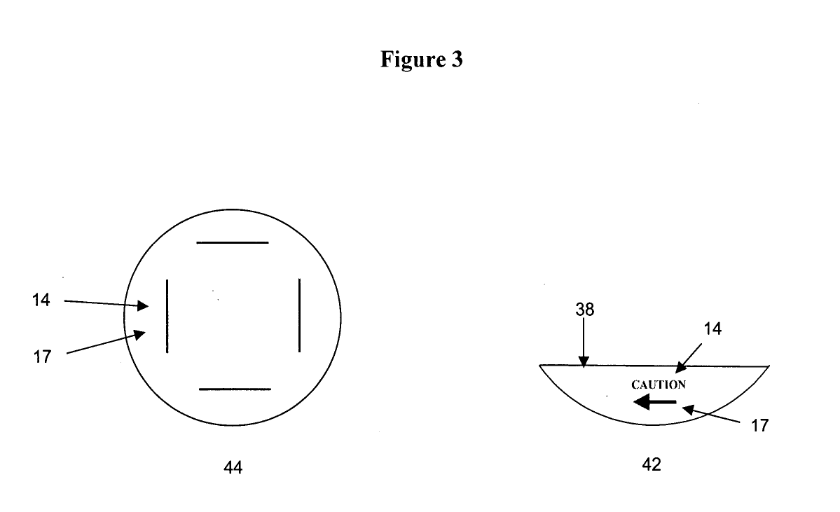

FIG. 3 shows two views of an embodiment of Forklift Activated Mirror Warning System 10. Invention mirror is a full dome mirror 38 shown in side view as 42 and underside view as 44. Such a full dome mirror 38 could be placed in a busy cross-corridor intersection. Flashing alarm 14 with arrow 17 that point to the approaching danger would that show Caution or the equivalents such as Danger and an arrow pointing to the direction of the approaching forklift. Such warning may be in other languages such as Spanish. Likewise, the warning light may be is a programmable scrolling message board so that a message, such as “Forklift Approaching” is visible when activated. The dome mirror alert can be constructed so that pedestrian and forklift operators in cross aisles are warned as they approach a 4-way intersection.

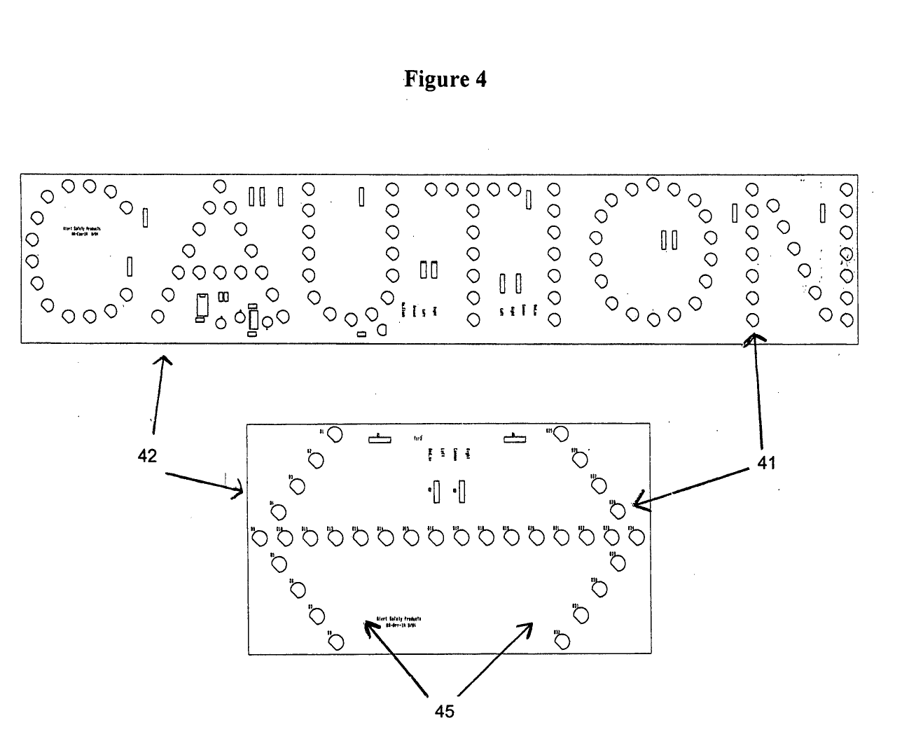

FIG. 4 shows a series of light emitting diodes 41 placed on PC boards 42 in an arrangement that outlines the word Caution, as well as direction arrows 45 □ and □. Light emitting diodes are preferred as the source of light for the present invention. However, it is appreciated that other kinds of light sources, including lasers, may be used.

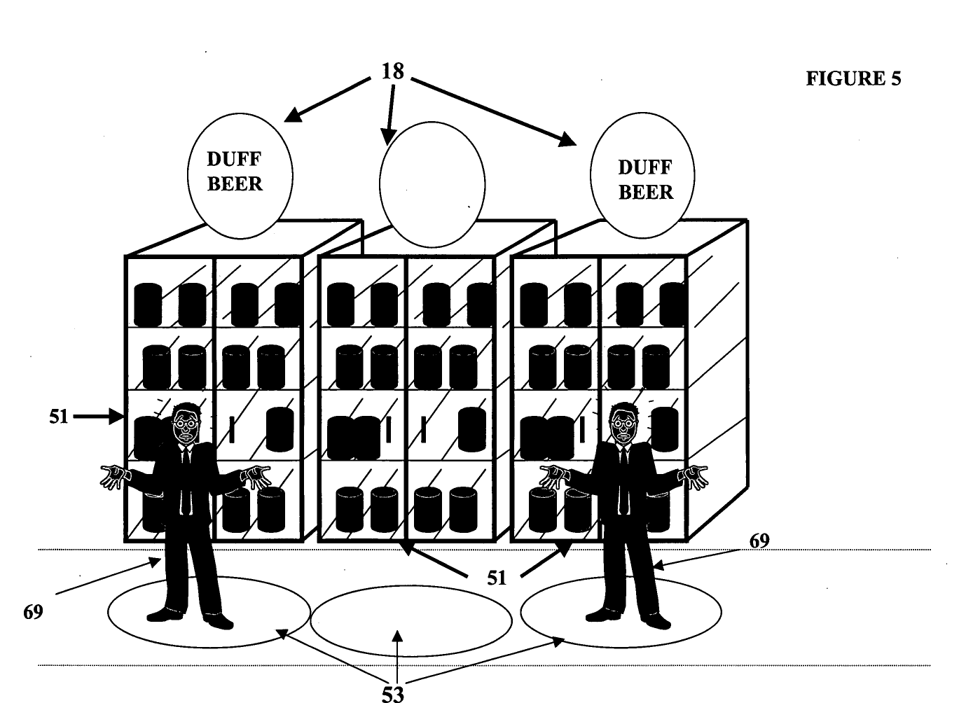

FIG. 5 shows the elements of the present invention, that is, shaped transparent mirror with a light that transmits through the mirror with information. This information light is activated when a person or object approaches the vicinity of the mirror. FIG. 5 shows the alternative embodiment in action. FIG. 5 illustrates a closed upright commercial cooler for soft drinks 51. A zone of activation 53, which can be a pressure pad, sonic, microwave, or light trigger activates light sources in dome mirror 18 is activated as customer 69 approaches. The dome light would flash constantly or intermittently with an advertising message such as “DuffBeer.” Likewise, the dome light may be a laser, or a lightbox and graphics which can project a more complex picture on the inner surface of the mirror such as a person drinking a “Duff Beer. The flashing light would serve two purposes: First it would inform the clerk that the soft drink cooler is about to be opened. Second it would provide an advertising stimulus to the customer. Of course, the mirror would provide a safety tool to inform the clerk about other customers in the manner of usual observation mirrors.

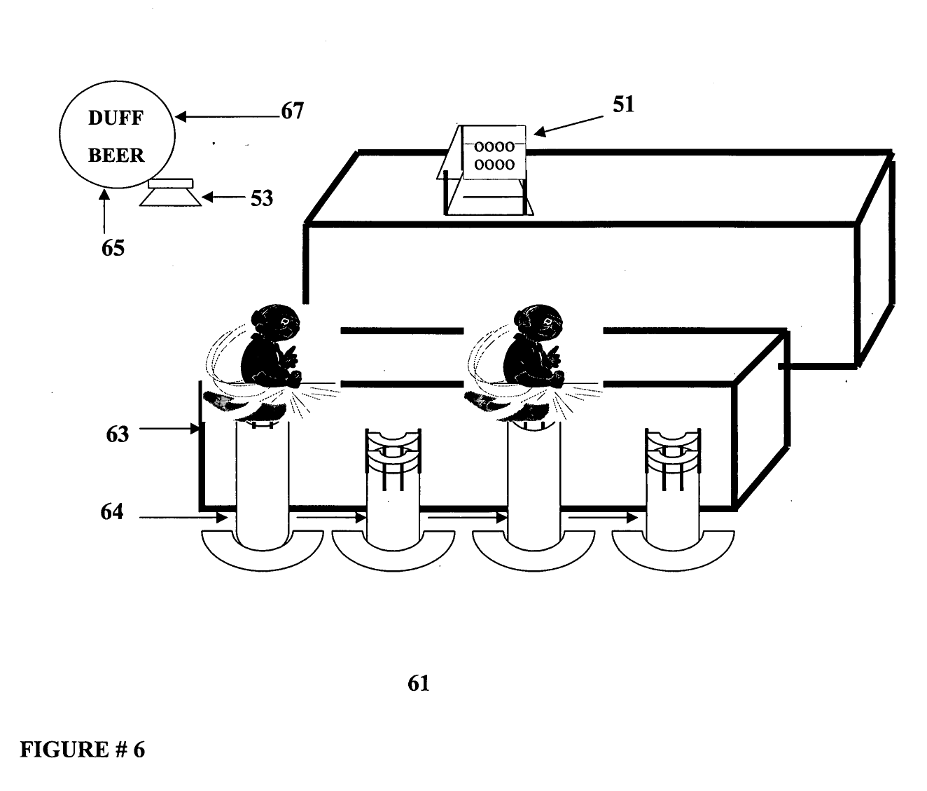

FIG. 6 shows an outline of a bar establishment 61. Shown is a longer narrow bar 63 and bar stools 64. A convex advertisement mirror 65 with a product mention 67 (in this case DUFF BEER). The Duff Beer notice may be activated via activation means such as wire or wireless whenever a sale is made and recorded in cash register 51. Alternatively the “Duff Beer” notice may be activated when a photocell beam or other means of motion detection is activated 53. Alternatively, when the barstool 64 accepts a customer the weight of the customer would activate the “Duff Beer” notice.

The information placed through the mirror can likewise be a light box with graphics overlay so a full color image will be visible behind the mirror when the light source is activated.

We claim:

1) A warning or information mirror system comprising:
a semi transparent (see thru) mirror;
a warning or information light is placed behind said mirror;
a detection means to create a signal;
a signal transfer means;
a means to activate said warning or information mirror system
said detection means transfers information through signal transfer means which activates said warning or information light;
illumination from said warning light passes through said curved mirror to warn or provide information to the client;
wherein said timing device deactivates said warning light after a preset time interval;
or the device is deactivated by the deactivation means after the stimulus for the activation means exits the area.

2) A mirror warning or information system as in claim 1) wherein said signal transfer means is either wireless or with wires.

3) A mirror warning or information system as in claim 1) wherein an auditory alarm is activated by said signal transfer means.

4) A mirror warning or information system as in claim 1) wherein said curved mirror is a bowed flat mirror, a convex mirror, half dome, full dome or any other shape semi-transparent (see-thru) mirror.

5) A mirror warning or information system as in claim 1) wherein said warning light is a laser which will project an image (text or graphics) on the surface of the mirror so that it is visible only when activated.

6) A mirror warning or information system as in claim 1) wherein said warning light placed in the context of said curved mirror is a light box with graphics overlay so a full color image will be visible behind the mirror when activated.

7) A mirror warning or information system as in claim 1) wherein said warning light placed in the context of said curved mirror is a programmable scrolling message board so that a message, such as “Forklift Approaching” is visible when activated.

8) A mirror warning or information system as in claim 1) wherein said system has failsafe circuitry that will flash a green LED (or other type of visual display) to indicate that the Mirror Alert System is functioning.

9) A forklift activated mirror warning system comprising:
a means to detect the approaching forklift;
a signal transfer means;
a curved mirror;
a warning light;
a timing device;
said warning light is placed in the context of said curved mirror;
said detection means transfers information through signal transfer means which activates said warning light;
illumination from said warning light passes through said curved mirror to warn of approaching vehicle.
wherein said timing device deactivates said warning light after a preset time interval.

10) A forklift activated mirror warning system as in claim 9) wherein said signal transfer means is either wireless or with wires.

11) A forklift activated mirror warning system as in claim 9) wherein an auditory alarm is activated by said signal transfer means.

12) A forklift activated mirror warning system as in claim 9) wherein said curved mirror is a curved flat, flat, convex, half dome, full dome or any other shape semi transparent (see-thru) mirror.

13) A forklift activated mirror warning system as in claim 9) wherein said warning light placed in the context of said curved mirror is placed behind semi-transparent (see-thru) mirroring.

14) A forklift activated mirror warning system as in claim 9) wherein said warning light placed in the back of said curved mirror is a laser which will project an image (text or graphics) on the inner surface of the mirror so that it is visible only when activated.

15) A forklift activated mirror warning system as in claim 9) wherein said warning light placed in the back of said curved mirror is a light box with graphics overlay so a full color image will be visible behind the mirror when activated.

16) A forklift activated mirror warning system as in claim 12) wherein said warning light placed in the context of said curved mirror is a programmable scrolling message board so that a message, such as “Forklift Approaching” is visible when activated.

17) A forklift activated mirror warning system as in claim 9) wherein said curved mirror is a full dome (360 degree) mirror;
wherein said warning light comprises four separates lights in said full dome mirror so that pedestrian and forklift operators are warned in cross aisles as they approach a 4-way intersection.
